(19) United States
(12) Patent Application Publication
(10) Pub. No.: US 2011/0239604 A1
(43) Pub. Date: Oct. 6, 2011

(54) ADJUSTABLE WEED CUTTING TOOL

(76) Inventor: Daniel Scott Amundson, Winona, MN (US)

(21) Appl. No.: 13/026,778

(22) Filed: Feb. 14, 2011

Related U.S. Application Data
(60) Provisional application No. 61/309,581, filed on Mar. 31, 2010.

(51) Int. Cl. A01D 44/00

(52) U.S. Cl. 56/8

(57) ABSTRACT

The weed cutting tool (10) comprises a handle (12) and two adjustable cutting arms (14) extending outwardly from the handle (12) and lying in a single plane, the arms (14) being pivotably adjustable toward and away from the handle (12), in increments, to accommodate cutting various densities of weeds growing along shorelines of bodies of water.

### RELATED APPLICATION

This application claims the benefit of U.S. Provisional Application No. 61/309,581 filed Mar. 31, 2010, which is hereby incorporated herein by reference.

### BACKGROUND OF THE INVENTION

The present application relates to tools for cutting down weeds in bodies of water, in particular to tools having adjustable cutting arms used in cutting down submerged vegetation near the root.

There is an increased use of shoreline along bodies of water for recreational uses. However, not all shoreline is desirably free from weeds and other vegetation growth. Owners of this type of property, in many instances, wish to remove the weeds and below the water growth along shorelines.

One ineffective solution is to remove the vegetation by hand with or without a hand tool. This requires wading into the water and the use of shovels to dig out the roots of the vegetation. Another ineffective solution is to use a knife. This method requires the laborer to bend over and work in a situation where the water impairs the view of the cutting operation.

There have been various other attempts at creating tools for the cutting of aquatic vegetation. These tools can be used by hand or used by tossing the tool into the water on a tethered line, followed by pulling the tool along the shoreline to perform a cutting operation. All of these tools have their limitations and are not efficient. Some have blades that are hazardous to the user. Others have blades that are in an ineffective position to cut and retrieve the vegetation. Most have fixed blades. Still others cannot work in a situation where the vegetation is of a varied nature.

The fact of the mater is the density and variation of vegetation encountered when using cutters can be highly variable. Some vegetation contains thick fibrous stalks and others are thin and filamentous. Depending on the vegetation type, density and heterogeneity of the vegetation, most tools can be difficult to use and are not effective in cutting vegetation of a variable nature. In nature, a wide instance of this type of growth occurs. Thus these tools are largely un-effective in this situation.

In some cases tools can be difficult to pull through vegetation because the cutting width is too large to effectively pass through the vegetation. In other cases the vegetation is too filamentous to effectively slough off the cutting edges during retrieval limiting the effectiveness of the tool. Foreign matter and vegetation can also catch on the tool during use.

There are also cases where the vegetation is sufficiently sparse that a wider cutting position angle would increase the efficiency of the tool by clearing larger areas with each pass. Most tools are unable to accomplish this adjustment.

Those tools having adjustment, such as the V shaped cutters, have fixed blades and in order to change the position angle of the blades the tool must be partially disassembled. This can be time consuming and excessive handling of this tool for assembly and disassembly can increase the risk, to the user, of being cut by one of the cutting blades.

Another disadvantage of the tools configured in a V shape. The distance between the end of the cutting blades can be as much as 50 inches. Thus the fixed V shape makes storage problematic.

Accordingly there is a need for an adjustable weed cutting tool which overcomes the limitations of other tools, noted above, and allows for adjustability, adjustability without disassembly, versatility of the cutter for various vegetation types and densities, efficiency at not allowing foreign matter to collect on the tool during use, compactly storable and safe.

### SUMMARY OF THE INVENTION

In one embodiment, weed cutting tool is provided that includes: a segmented handle having a first end and a second end opposite the first end, the segmented handle having a length between the first and second ends; a plurality of cutting arms pivotally coupled to the segmented handle at an engagement member located between the first and second ends of the segmented handle proximate to the first end, each of the cutting arms having a cutting edge, the segmented handle further having a plurality of detents therein along at least a portion of the length of the segmented handle; a slider coupled movably to the segmented handle so as slide lengthwise along at least a portion of the length of the segmented handle, the slider lockable at each of the plurality of detents; and a plurality of adjustment arms, each of the adjustment arms pivotally coupled to a cutting arm and the slider, wherein lengthwise movement in the slider causes the cutting arms to pivot about the engagement member inward and outward relative to the segmented handle between a plurality of positions.

In one embodiment, the plurality of cutting arms extend outwardly in a common plane.

In one embodiment, the plurality of detents are located between the first end and the engagement member.

In one embodiment, the slider is located between the first end and the engagement member.

In one embodiment, wherein the detents are holes in the segmented handle at predefined distances there between, the slider lockable at each detent with a removable pin passing through a hole in the slider and at least one of the detents.

In one embodiment, the detents are popup buttons that engage a hole in the slider.

In one embodiment, the segmented handle comprises a plurality of segments releasably connected to each other.

In one embodiment, at least one of the segments include a male type coupling that fits into a female type coupling at an opposite end of another of the segments.

In one embodiment, at least one of the female and the male type couplings including a depressible lug that interconnects with a bore in another of the one of the female and male type couplings.

In one embodiment, the weed cutting tool further includes a hand grasp located at the second end of the segmented handle.

In one embodiment, the cutting arms are adjustable between a plurality of V shaped positions.

In one embodiment, the cutting edge of each of the cutting arms point outwardly.

In one embodiment, the weed cutting tool includes at least 4 detents.

Additional aspects of the present invention will be apparent in view of the description which follows.

### BRIEF DESCRIPTION OF THE FIGURES

FIG. 1 is a side elevation view of the adjustable weed cutting tool according to one embodiment of the tools disclosed herein.

FIG. 2 is a side elevation view showing a first position of the adjustable cutting arms

FIG. 3 is a side elevation view showing a second position of the adjustable cutting arms.

FIG. 4 is a side elevation view showing a third position of the adjustable cutting arms.

FIG. 5 is a side elevation view showing a fourth position of the adjustable cutting arms.

FIG. 6 is an enlarged elevation view of the adjustment system of the tool.

### DETAILED DESCRIPTION OF THE INVENTION

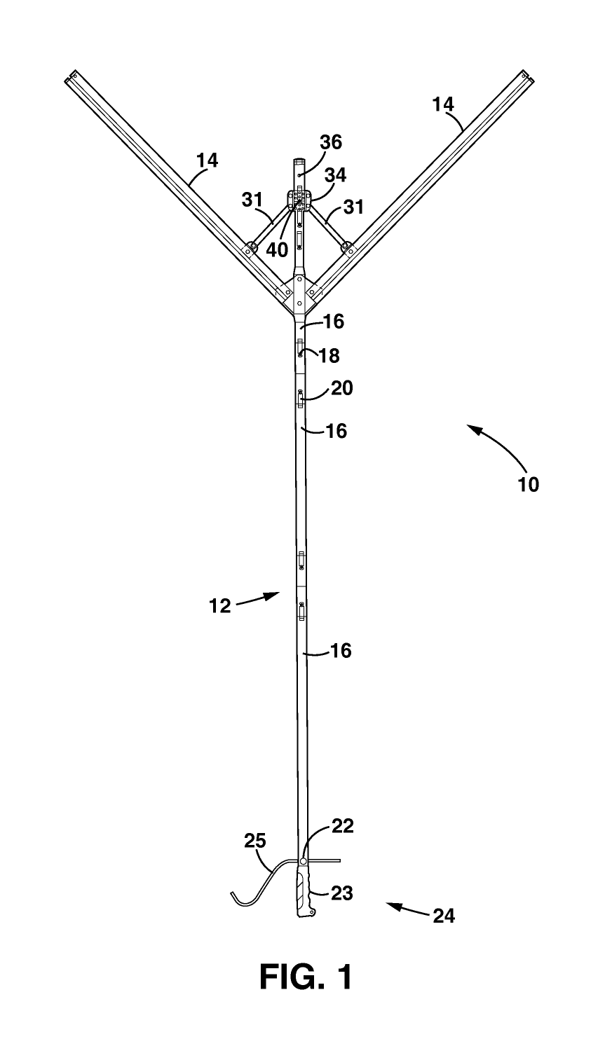

Referring to FIG. 1 and other drawings in greater detail, there is illustrated herein the weed cutting tool 10 of the present invention generally identified by reference numeral 10. A tool 10 is constructed of metal in the preferred embodiment and could also be made of plastic or other materials, or a combination of materials. A tool 10 comprises a segmented handle 12 with two oppositely disposed cutting arms 14 extending outwardly in a plane there from.

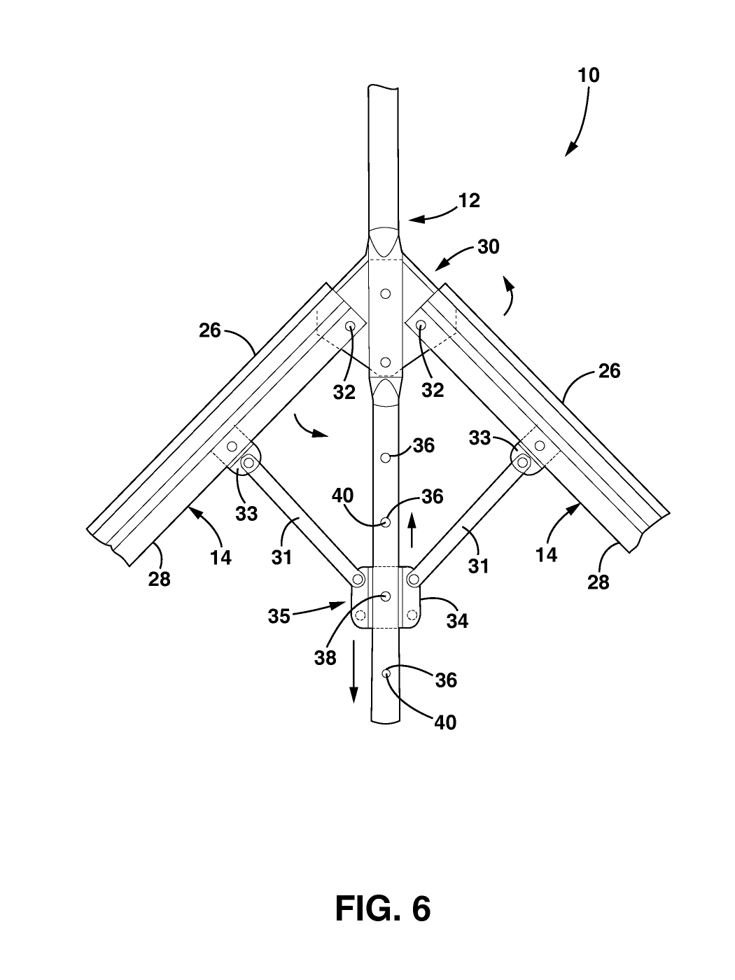

FIG. 1 through FIG. 6 illustrate a light weight variable V-shaped aquatic vegetation cutting tool 10 for the efficient removal of aquatic weeds and other vegetation growing from the bottom of bodies of water, rivers or streams or for the harvesting of aquatic weeds and crops.

In the preferred embodiment, the handle is made of a plurality of segments 16 that are releasably connected together end to end. The releasability may be achieved in a variety of ways. For example one end of the segment 16 may have a male type coupling that fits into a female type coupling at an opposite end of another segment 16. In one embodiment, one of the ends of a segment 16 includes one or more depressible lugs 18 that interconnect within bores 20 in a contiguous segment 16. A through bore 22 may be provided in a free end 24 of a terminal segment 16, just distal to a terminal hand grasp 23, by means of which a retrieving/pulling rope or line 25 is made fast to the handle. In this respect, multiple segments 16 may be coupled to achieve a desired overall length of the tool 10.

A tool 10 can be used in hand or by tossing the cutter into the water on a tethered line 25 or rope. A tool 10 is retrieved using a jerking motion on the rope to sever or shear the vegetation near the bottom as it encounters the cutting edge of cutting arms 14.

To describe the cutting arms 14, it will be understood that one elongated edge 26 of each arm 14 facing away from the handle 12 is razor sharp while an opposite elongated edge 28 is not. The cutting arms 14 engage adjustably to the handle 12 via a diamond shaped engagement member 30 engaging the handle 12 as well as pivotably engaging one end 32 of each cutting arm 14.

The V orientation of these blades on cutting arms 14 makes a tool 10 ideal for cutting submerged vegetation. The position angle of the cutting blades on cutting arms 14 is such that much of the vegetation slides off the ends of the bladed as a tool 10 is being retrieved. The profile of a tool 10 is also very sleek, with limited surfaces or hardware where vegetation and other foreign matter can catch on the surfaces, during use, making tool 10 more effective.

A pair of adjustment arms 31 is also provided, each adjustment arm 31 is pivotably engaged at one end to an engagement flange 33 extending from elongated edge 28 of one of the cutting arms 14 and at another end pivotably to an adjustment mechanism slider 34 in the form of a slider 34 which rides along a distal end portion 35 of the handle 12, distal to the engagement member 30.

A plurality of openings 36 is provided along the distal end 35 of the handle 12, and the slider 34 slides along the distal end 35, with a central opening 38 thereof aligning over a desired opening 36 that creates the desired angle of the cutting arms 14. When so aligned a fixation member 40, such as an insertable pin, or pop up button interior to the opening 36 fixes the adjustable arms 32 in position, maintaining cutting arms 14 in the desired extended position.

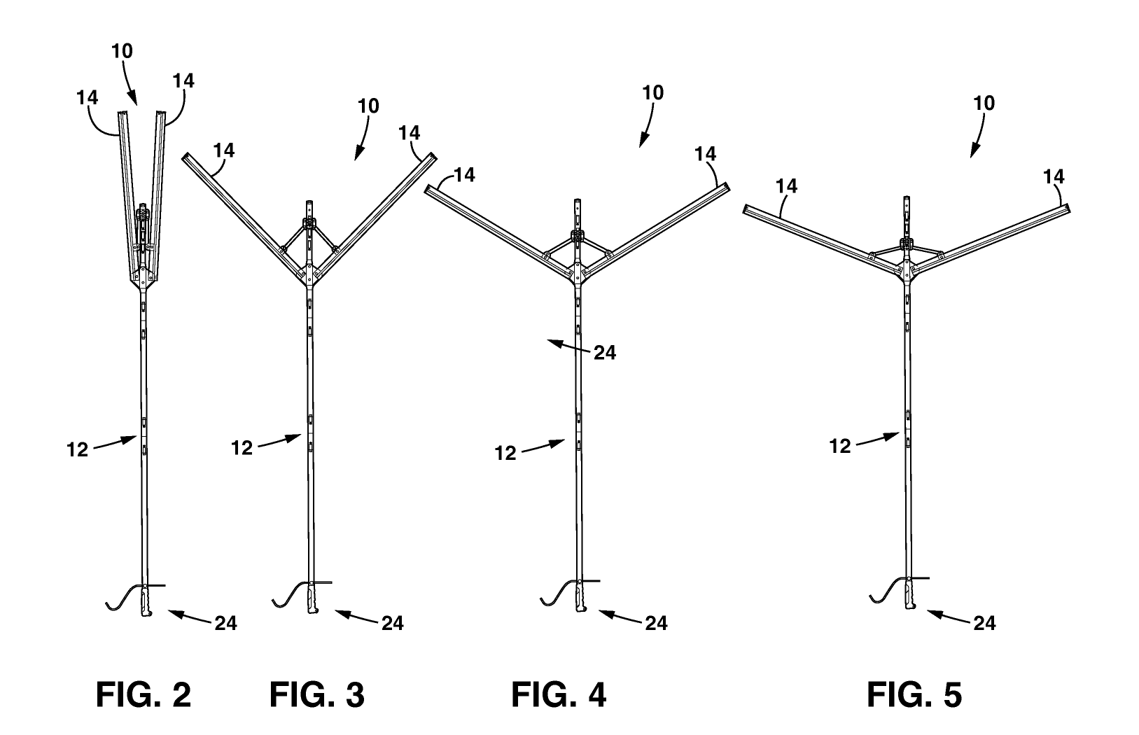

This adjustability as disclosed in FIG. 2 through FIG. 5 provides a benefit with respect to the density of weeds one is cutting through, with narrowly set cutting arms 14 handling thicker densities and wider set arms 14 handling lesser densities. Further, when a tool 10 is collapsed as shown in FIG. 2, it is more easily stored.

As described above, the adjustable weed cutting tool 10 of the present invention provides a number of advantages, some of which have been described above and others of which are inherent in the invention. Also, modifications may be proposed to a tool 10 without departing from the invention disclosed herein. Accordingly the scope of the invention is only to be limited as necessitated by the accompanying claims.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A weed cutting tool comprising:
a segmented handle having a first end and a second end opposite the first end, the segmented handle having a length between the first and second ends;
a plurality of cutting arms pivotally coupled to the segmented handle at an engagement member located between the first and second ends of the segmented handle proximate to the first end, each of the cutting arms having a cutting edge, the segmented handle further having a plurality of detents therein along at least a portion of the length of the segmented handle;
a slider coupled movably to the segmented handle so as to slide lengthwise along at least a portion of the length of the segmented handle, the slider lockable at each of the plurality of detents; and
a plurality of adjustment arms, each of the adjustment arms pivotally coupled to a cutting arm and the slider, wherein lengthwise movement in the slider causes the cutting arms to pivot about the engagement member inward and outward relative to the segmented handle between a plurality of positions .

2. The weed cutting tool of claim 1, wherein the plurality of cutting arms extend outwardly in a common plane.

3. The weed cutting tool of claim 1, wherein the plurality of detents are located between the first end and the engagement member.

4. The weed cutting tool of claim 3, wherein the slider is located between the first end and the engagement member.

5. The weed cutting tool of claim 1, wherein the detents are holes in the segmented handle at predefined distances there between, the slider lockable at each detent with a removable pin passing through a hole in the slider and at least one of the detents.

6. The weed cutting tool of claim 1, wherein the detents are popup buttons that engage a hole in the slider.

7. The weed cutting tool of claim 1, wherein the segmented handle comprises a plurality of segments releasably connected to each other.

8. The weed cutting tool of claim 7, wherein at least one of the segments include a male type coupling that fits into a female type coupling at an opposite end of another of the segments.

9. The weed cutting tool of claim 8, at least one of the female and the male type couplings including a depressible lug that interconnects with a bore in another of the one of the female and male type couplings.

10. The weed cutting tool of claim 1, comprising a hand grasp located at the second end of the segmented handle.

11. The weed cutting tool of claim 1, wherein the cutting arms are adjustable between a plurality of V shaped positions.

12. The weed cutting tool of claim 11, wherein the cutting edge of each of the cutting arms point outwardly.

13. The weed cutting tool of claim 1, comprising at least 4 detents.

14. A weed cutting tool comprising:
a segmented handle having a first end and a second end opposite the first end, the segmented handle having a length between the first and second ends;
a plurality of cutting arms pivotally coupled to the segmented handle at an engagement member located between the first and second ends of the segmented handle proximate to the first end, each of the cutting arms having a cutting edge, the plurality of cutting arms extend outwardly in a common plane, the segmented handle further having a plurality of detents therein along at least a portion of the length of the segmented handle between the first end and the engagement member;
a slider located between the first end and the engagement member, the slider coupled movably to the segmented handle so as slide lengthwise along at least a portion of the length of the segmented handle, the slider lockable at each of the plurality of detents; and
a plurality of adjustment arms, each of the adjustment arms pivotally coupled to a cutting arm and the slider, wherein lengthwise movement in the slider causes the cutting arms to pivot about the engagement member inward and outward relative to the segmented handle between a plurality of positions.

15. The weed cutting tool of claim 14, wherein the segmented handle comprises a plurality of segments releasably connected to each other.

16. The weed cutting tool of claim 15, wherein at least one of the segments include a male type coupling that fits into a female type coupling at an opposite end of another of the segments.

17. The weed cutting tool of claim 16, at least one of the female and the male type couplings including a depressible lug that interconnects with a bore in another of the one of the female and male type couplings.

18. The weed cutting tool of claim 14, comprising a hand grasp located at the second end of the segmented handle.

19. The weed cutting tool of claim 14, wherein the cutting arms are adjustable between a plurality of V shaped positions.

20. The weed cutting tool of claim 19, wherein the cutting edge of each of the cutting arms point outwardly.
